(19) United States
(12) Patent Application Publication
(10) Pub. No.: US 2026/0066549 A1
(43) Pub. Date: Mar. 5, 2026

(54) ACTIVE STEERING FOR ULTRA-WIDEBAND ANTENNA

(71) Applicant: KYOCERA AVX Components (San Diego), Inc., San Diego, CA (US)

(72) Inventor: Olivier Pajona, Biot (FR)

(21) Appl. No.: 19/306,623

(22) Filed: Aug. 21, 2025

Related U.S. Application Data
(60) Provisional application No. 63/689,006, filed on Aug. 30, 2024.

(51) Int. Cl. H01Q 19/00; H01Q 1/22; H01Q 1/48; H01Q 5/25

(52) U.S. Cl. CPC H01Q 19/00; H01Q 1/22; H01Q 1/48; H01Q 5/25

(57) ABSTRACT

A modal antenna assembly is provided. The modal antenna includes an antenna element comprising a curved conical portion and a top portion, the top portion comprising an undulating annular ring disposed on the curved conical portion. The modal antenna further includes a parasitic element positioned at least partially within a gap defined in the curved conical portion of the antenna element.

### PRIORITY CLAIM

The present application claims the benefit of priority of U.S. Provisional Application Serial No. 63/689,006, filed on August 30, 2024, which is incorporated herein by reference.

### FIELD

The present disclosure relates generally to a modal antenna, and more particularly to an ultra-wideband modal antenna configured to provide more uniform gain and uniform phase in multiple directions across a large bandwidth of frequencies, such as from about 3 GHz to about 12 GHz.

### BACKGROUND

Antennas can be used to facilitate wireless communication between devices. It can be desirable for antennas to operate across a wide range of frequencies, such as in the superhigh frequency band, such as from about 3 GHz to about 12 GHz. Frequencies in the superhigh frequency band can span the S-band, C-band, and X-band. Antennas operable in these frequency bands can be used for a variety of applications, including satellite communications, radar, weather radar, navigational assistance, vessel identification and tracking, air traffic control, inflight Wifi, spacecraft telemetry and other applications.

### SUMMARY

Aspects and advantages of embodiments of the present disclosure will be set forth in part in the following description, or can be learned from the description, or can be learned through practice of the embodiments.

One aspect of the present disclosure is directed to a modal antenna. The modal antenna includes an antenna element comprising a curved conical portion and a top portion, the top portion comprising an undulating annular ring on the curved conical portion. The modal antenna further includes a parasitic element positioned at least partially within a gap defined in the curved conical portion of the antenna element.

Another aspect of the present disclosure is directed to a method for controlling a modal antenna. The method includes determining, by one or more control devices, a selected mode of a plurality of modes for the modal antenna, each mode of the plurality of modes associated with a distinct radiation pattern of the modal antenna. The method further includes controlling, by the one or more control devices, a parasitic element of the modal antenna to configure the modal antenna in the selected mode, the parasitic element positioned at least partially within a gap defined in a curved conical portion of an antenna element of the modal antenna.

Another aspect of the present disclosure is directed to an electronic device. The electronic device includes a circuit board having a ground plane. The electronic device further includes a modal antenna positioned on a first surface of the circuit board. The modal antenna includes an antenna element comprising a curved conical portion and a top portion, the top portion comprising an undulating annular ring disposed on the curved conical portion. The modal antenna further includes a parasitic element positioned at least partially within a gap defined in the curved conical portion of the antenna element.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides a perspective view of a modal antenna according to example embodiments of the present disclosure;

FIG. 2 provides another perspective view of the modal antenna of FIG. 1 according to example embodiments of the present disclosure;

FIG. 3 provides a top-down view of the modal antenna of FIG. 1 according to example embodiments of the present disclosure;

FIG. 4 provides a side view of an antenna assembly having a modal antenna according to example embodiments of the present disclosure;

FIG. 5 depicts a two-dimensional radiation pattern associated with a modal antenna according to example embodiments of the present disclosure;

FIG. 6 provides a block diagram of an electronic device having a modal antenna according to example embodiments of the present disclosure; and

FIG. 7 depicts an example method for controlling a modal antenna according to example embodiments of the present disclosure;

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 15% of the stated numerical value.

In some antenna applications, it may be beneficial to determine positional data associated with a device on a network. For instance, in keyless entry applications, an antenna may provide one or more signal metrics such as signal direction, angle of arrival, and/or a time of flight over short distances to be used to determine positional data associated with a device. The positional data may be used to determine whether signals are being received from a legitimate device or if they are coming from a security compromised device (e.g., a device that is not located where it should be located). This can be particularly useful, for instance, in preventing the unauthorized capturing of information from keyless entries by devices that are not located proximate to equipment (e.g., automotive vehicle) or premises (e.g., a building).

Ultra-wideband (UWB) systems, when using well-designed UWB antennas may provide more accurate signal metrics, allowing for more precise determinations of, for instance, the location of and/or distance to a device on the network compared to other short-range antennas. Ultra-wideband antennas may be passive components, having fixed radiation patterns. The present disclosure provides an active UWB modal antenna capable of exhibiting multiple radiation patterns.

Example aspects of the present disclosure relate generally to a modal (e.g., multi-mode) antenna. The modal antenna may be an ultra-wideband modal antenna configured to operate in the super high frequency (SHF) band, such as at frequencies in a range from about 3 GHz to about 12 GHz. In addition, the modal antenna of the present disclosure is operable in a plurality of modes. Specifically, each mode of the plurality of modes may be associated with a distinct radiation pattern of the modal antenna. The modal antenna may be controlled to operate in a selected mode of the plurality of modes by, for instance, one or more control devices. In some implementations, operating the modal antenna in a selected mode of the plurality of modes may provide for improved signal quality when compared to passive antennas having a fixed radiation pattern.

The modal antenna according to example aspects of the present disclosure can provide numerous technical benefits and advantages. For instance, the modal antenna may be an ultra-wideband modal antenna configured to operate in the super high frequency (SHF) band, such as at frequencies in a range from about 3 GHz to about 12 GHz. This may provide for more accurate signal metrics (e.g., signal direction, angle of arrival, time of flight, etc.) when compared to other short-range antennas. In addition, the modal antenna may be configured among a plurality of modes, each mode of the plurality of modes associated with a distinct radiation pattern. Operating the modal antenna in a selected mode of the plurality of modes may provide for improved signal quality when compared to passive antennas having a fixed radiation pattern. Operating the modal antenna with a plurality of different radiation patterns may allow for the ability to determine metrics (e.g., signal direction, angle of arrival, time of flight, etc.) without requiring multiple passive antennas.

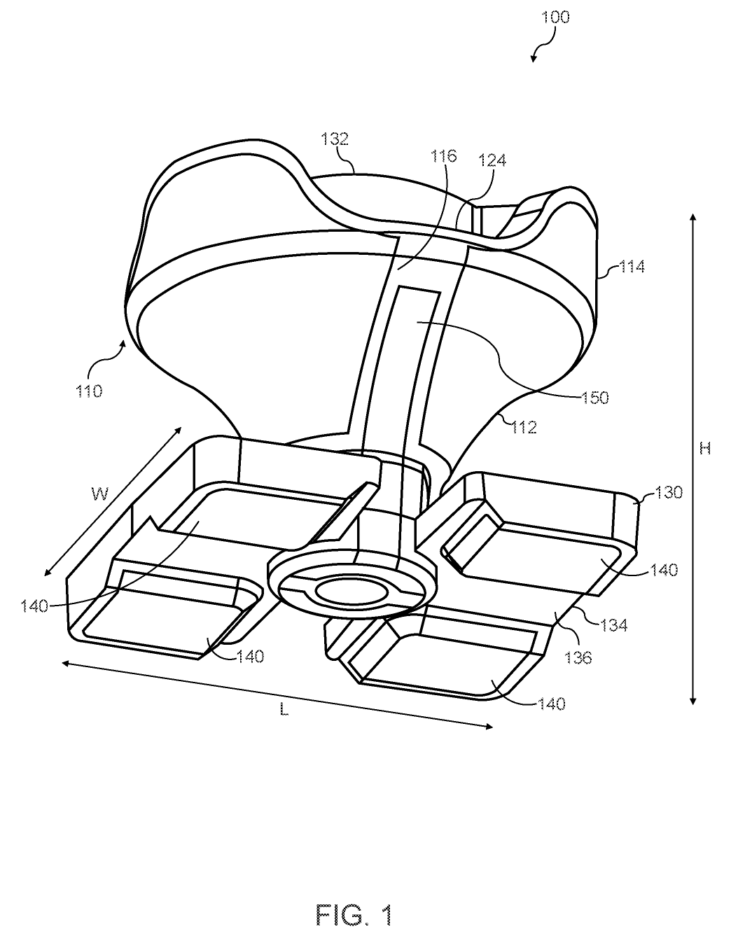

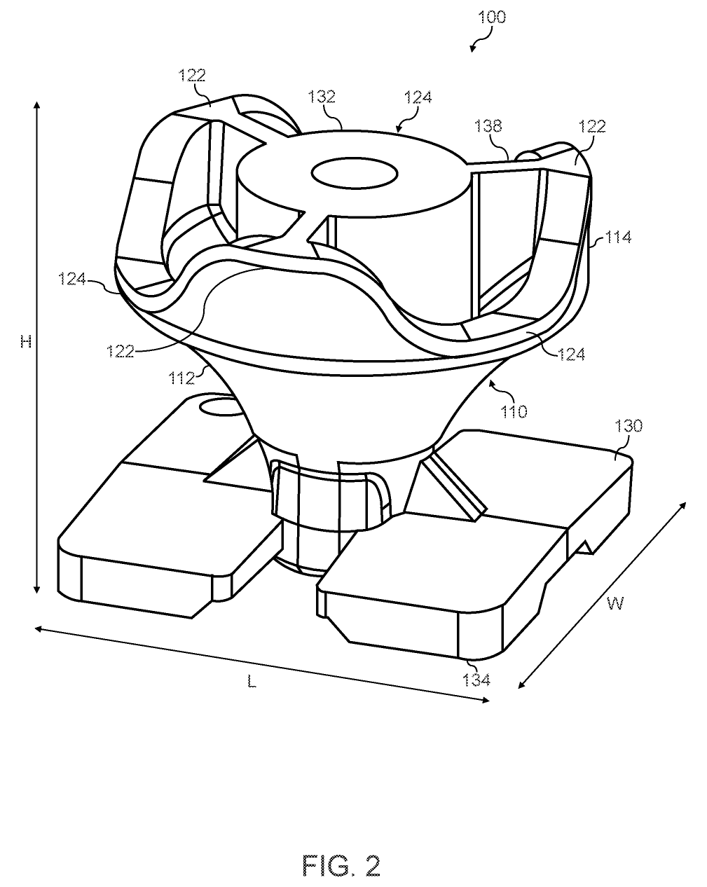

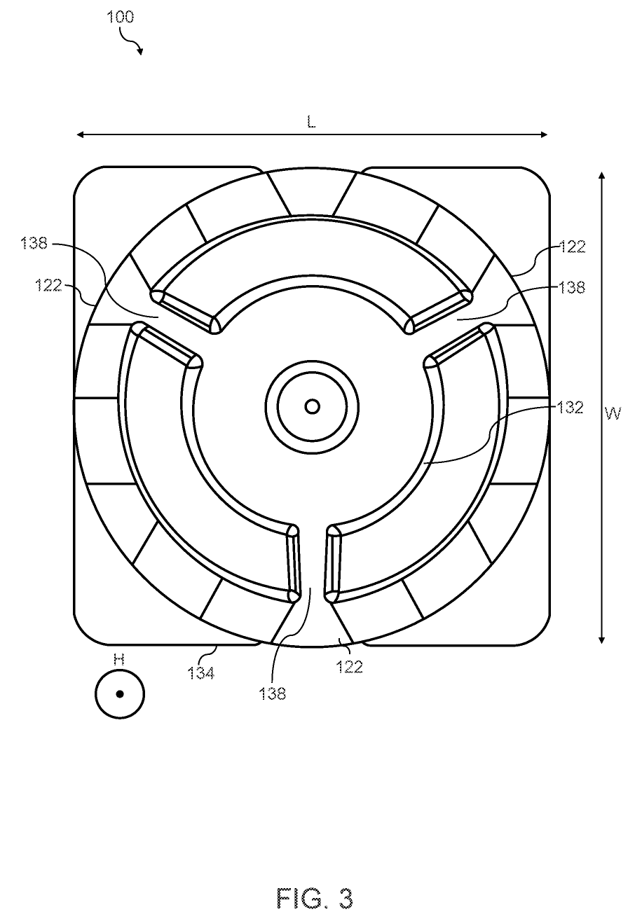

Referring now to the FIGS, FIGS. 1-3 illustrate modal antenna 100 according to example embodiments of the present disclosure. Specifically, FIGS. 1-2 depict perspective views of modal antenna 100 while FIG. 3 provides a top-down view of modal antenna 100. As shown, modal antenna 100 may define a height dimension H (e.g., height), a length dimension L (e.g., length), and a width dimension W (e.g., width). The height dimension H, length dimension L, and width dimension W may extend in mutually perpendicular directions and form an orthogonal direction system.

Modal antenna 100 includes an antenna element 110. Antenna element 110 may include a curved conical portion 112 and top portion 114 disposed on (e.g., above) the curved conical portion 112. As shown particularly in FIG. 2, top portion 114 may be an undulating annular ring. The undulating annular ring may be a sinusoid structure. For instance, the undulating ring of top portion 114 can have a shape that, if extended in a straight line, resembles a sinusoid (e.g., a curve having the form of a sine wave). In some embodiments, the undulating annular ring can have a plurality of curved peaks 122 and a plurality of curved valleys 124, such as three curved peaks 122 and three curved valleys 124. The height of the curved peaks 122 may be greater than a height of the curved valleys 124. While the annular ring of top portion 114 as shown in FIGS. 1-2 has three curved peaks 122 and three curved valleys 124, the annular ring can include more or fewer curved peaks and curved valleys without deviating from the scope of the present disclosure. In some embodiments, the curved peaks 122 and the curved valleys 124 may occur at regular intervals about the annular ring.

Antenna element 110 may further include a curved conical portion 112. As shown in FIG. 1, a gap 116 may be defined in the curved conical portion 112 of antenna element 110. The gap 116 may extend entirely through the curved conical portion 112 such that antenna element 110 is not fully enclosed (e.g., along the height dimension). In some embodiments, gap 116 may correspond to a curved valley 124 of the undulating annular ring. For example, gap 116 may align with a curved valley 124 in the height dimension.

Modal antenna 100 may further include a carrier 130. Carrier 130 may have a first portion 132 configured to support at least a portion of antenna element 110. First portion 132 of carrier 130 may include a ring shaped structure positioned at least partially within the antenna element 110 (e.g., relative to the length-width plane). First portion 132 may further include one or more support arms 138 extending from the ring shaped structure to top portion 114 of antenna element 110. In some embodiments, each support arm 138 of the first portion 132 may extend to a curved peak 122 of the antenna element 110. For example, modal antenna 100 may include three support arms 138 corresponding to three curved peaks 122. As such, first portion 132 of carrier 130 may support curved conical portion 112 and top portion 114 of antenna element 110. Carrier 130 may further include a base portion 134 configured to support the first portion 132 of the carrier 130. Base portion 134 may be a generally rectangular structure, such as a three-dimensional rectangular structure. In some embodiments, base portion 134 may have a width dimension that is about the same as a length dimension of the base portion 134. For example, base portion 134 may have a length dimension that is about 6 millimeters (mm) and a width dimension that is about 6 mm.

As best shown in the top-down view provided by FIG. 3, the width dimension and the length dimension of modal antenna 100 may correspond to the length dimension and width dimension of the base portion 134. The undulating ring (e.g., top portion 114) of the antenna element 110 may have a diameter that is about the same, such as equivalent to, the length dimension and/or the width dimension of the base portion 134 of the carrier 130.

In some embodiments, the height dimension, length dimension, and width dimension of modal antenna 100 may be about the same. For instance, the height dimension, length dimension, and width dimension of modal antenna 100 may be about 6 mm. Alternatively, the height dimension of modal antenna 100 may be less than the width and length dimensions. In some embodiments, each dimension (e.g., height, width, and length) of modal antenna 100 is less than 10 mm, such as less than 7 mm.

As best shown in FIG. 1, modal antenna 100 may include one or more coupling points 140 to couple (e.g., operatively couple) the modal antenna 100 to, for instance, a circuit board. For example, a first surface 136 of base portion 134 may be coupled to a circuit board. In some embodiments, modal antenna 100 may include four coupling points 140 positioned on first surface 136, each coupling point 140 positioned proximate to a corner of the first surface 136. The coupling points 140 may be rectangular or square pads, such as soldering pads.

As best shown in FIG. 1, modal antenna 100 further includes a parasitic element 150 positioned at least partially within gap 116 defined in the curved conical portion 112 of antenna element 110. Specifically, parasitic element 150 may be positioned at least partially along a plane (e.g., curved plane) defined by the curved conical portion 112 of antenna element 110. For example, both the parasitic element 150 and the curved conical portion 112 of antenna element 110 may extend along the same curved plane, such as the curved plane associated with the exterior surface of carrier 130. Parasitic element 150 may extend from gap 116 to a feed point located on the first surface 136 of the base portion 134. In some embodiments, parasitic element 150 may be a rectangular, ribbon structure defined on the exterior surface of carrier 130.

In some embodiments, modal antenna 100 may be a laser direct structuring (LDS) defined antenna. For example, carrier 130 may be a laser direct structuring (LDS) carrier. For example, a laser device may be used to etch one or more channels into an exterior surface of carrier 130. Antenna element 110 and parasitic element 150 may then be formed in the channels by, for example, placing carrier 130 in a metal bath such that the channels are filled with metal. As such, carrier 130, along with antenna element 110 and parasitic element 150, may be defined as an LDS antenna.

In some embodiments, the modal antenna 100 may be an ultra-wideband (UWB) modal antenna 100. For example, modal antenna 100 may be configured to operate across a wide range of frequencies, such as in the superhigh frequency band, such as from about 3 GHz to about 12 GHz. In some embodiments, modal antenna 100 may further include an active tuning element coupled to parasitic element 150. The active tuning element may be configured to adjust a mode of the modal antenna 100 among a plurality of modes, each mode of the plurality of modes associated with a distinct radiation pattern.

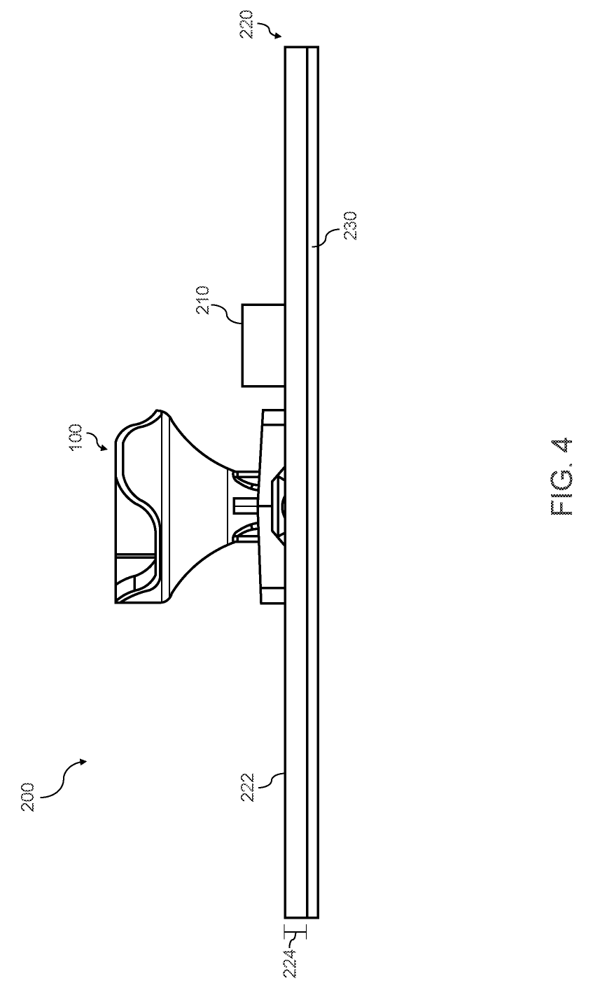

Referring now to FIG. 4, a side view of an antenna assembly 200 according to example embodiments of the present disclosure is provided. As shown, antenna assembly 200 may include a circuit board 220, an active tuning element 210, and a modal antenna, such as modal antenna 100 shown in FIGS. 1-3.

Modal antenna 100 and active tuning element 210 may be positioned on a first surface 222 of circuit board 220. Circuit board 220 may include a ground plane 230 (e.g., a conductive ground plane). In some embodiments, first surface 222 of circuit board 220 may be spaced apart (e.g., separated) from the ground plane 230 by thickness 224. Specifically, thickness 224 may be in a range from about 0.1 millimeter (mm) to about 5 mm. In some embodiments, the ground plane 230 may have an area that is substantially greater than an area (e.g., width by height) associated with a footprint of the modal antenna 100 on the circuit board 220. For instance, the ground plane 230 can have an area that is at least three times greater than an area associated with a footprint of the modal antenna 100 on the first surface 222 of the circuit board 220, such as five times greater, such as ten times greater, such as twenty times greater, or more.

As previously described, parasitic element 150 (FIG. 1) of modal antenna 100 may be coupled to (e.g. include) an active tuning element, such as active tuning element 210. Active tuning element 210 is configured to adjust a mode of the modal antenna 100 among a plurality of modes, each mode of the plurality of modes associated with a distinct radiation pattern.

The active tuning element 210 may include a passive or active component or series of components and can be configured to alter a reactance on the parasitic element 150 either by way of a variable reactance or shorting to ground. The active tuning element 210 may include a tunable capacitor, MEMS device, tunable inductor, switch, tunable phase shifter, a field-effect transistor or a diode. For example, active tuning element 210 may include a radio-frequency (RF) switch. In some embodiments, active tuning element 210 may be configured to adjust the mode of the modal antenna 100 by varying (e.g., altering) a reactance associated with the parasitic element 150 (FIG. 1). For example, active tuning element 210 may alter the reactance by way of variable reactance or by coupling the parasitic element 150 (FIG. 1) of the modal antenna 100 to the ground plane 230. Additionally and/or alternatively, active tuning element 210 may be configured to adjust the mode of the modal antenna 100 by connecting the parasitic element 150 to different loads with varying capacitance and/or inductance.

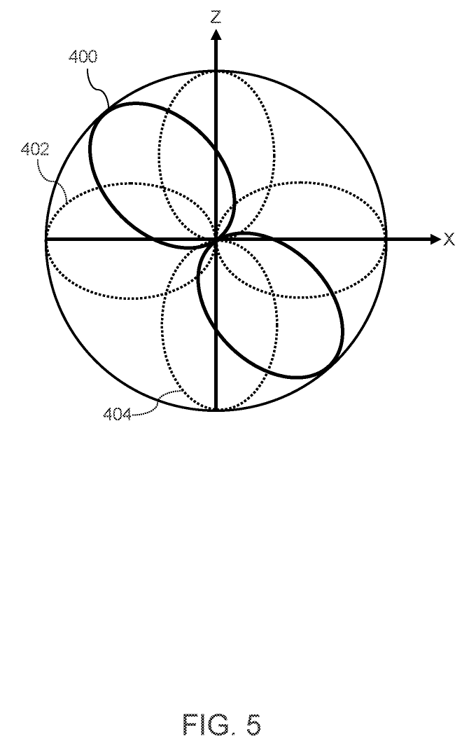

FIG. 5 depicts example antenna radiation patterns associated with modal antenna 100 according to example embodiments of the present disclosure. Specifically, FIG. 5 illustrates distinct radiation patterns 400, 402, 404 of the modal antenna 100 when in a first mode, second mode, and third mode. Those of ordinary skill in the art will understand that the two-dimensional shape of radiation patterns 400, 402, 404 are for purposes of illustration only, and that modal antenna 100 may be associated with any distinct radiation pattern when configured in each mode of the plurality of modes.

As shown in FIG. 5, the modal antenna 100 can have a first radiation pattern 400 when the modal antenna 100 is configured in a first mode of the plurality of modes. In addition, the modal antenna 100 can have a second radiation pattern 402 when the modal antenna 100 is configured in a second mode of the plurality of modes. Furthermore, the modal antenna 100 can have a third radiation pattern 404 when the modal antenna 100 is configured in a third mode of the plurality of modes. As shown, the first radiation pattern 400, the second radiation pattern 402, and the third radiation pattern 404 can be distinct from one another. In this manner, the modal antenna 100 can have a distinct radiation pattern (e.g., antenna radiation pattern) when configured in each of the first mode, second mode, and third mode.

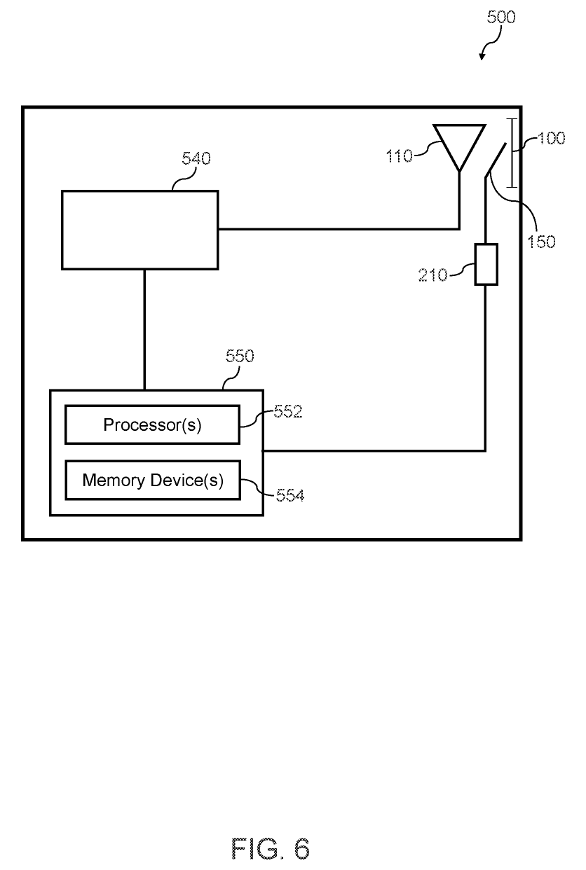

Referring now to FIG. 6, a block diagram depicting an example electronic device 500 is provided. Electronic device 500 may be any suitable electronic device configured to have wireless communication with one or more remote devices. For instance, electronic device 500 can be a computing device (e.g., laptop, desktop, display with one or more processors), mobile device (e.g., phone, tablet, wearable device (e.g., watch)), vehicle, nautical vehicle, aircraft, satellite, keyless entry device, or other electronic device. Those of ordinary skill in the art, using the disclosures provided herein, will understand that any of the antennas and/or antenna assemblies described herein can be used for a variety of applications and devices without deviating from the scope of the present disclosure. As shown in FIG. 6, electronic device 500 may include a modal antenna, such as modal antenna 100 shown in FIGS. 1-3.

As previously described, modal antenna 100 may include an antenna element 110 and a parasitic element 150. Modal antenna 100 may be operable in a plurality of different modes. Each mode of the plurality of modes may be associated with a distinct radiation pattern, such as radiation patterns 400, 402, 404 described above in reference to FIG. 5. Parasitic element 150 may be coupled to active tuning element 210 configured to adjust a mode of the modal antenna 100. In some embodiments, active tuning element 210 may adjust the mode of the modal antenna 100 by varying a reactance associated with the parasitic element 150.

As shown in FIG. 6, active tuning element 210 may be controlled by one or more control devices 550. Specifically, active tuning element 210 may be operably coupled to one or more control devices 550. Accordingly, the one or more control devices 550 may be configured to control operation of the active tuning element 210 to configure the modal antenna 100 in a selected mode of the plurality of modes. In this manner, the one or more control devices 550 may be configured to determine a selected mode of the plurality of modes.

In some embodiments, one or more control devices 550 may determine a selected mode of the plurality of modes for the modal antenna 100 based at least in part on one or more channel quality indicators. In some embodiments, the one or more channel quality indicators may be determined based on data indicative of a signal received by modal antenna 100. Additionally and/or alternatively, the one or more channel quality indicators may be determined based on data indicative of a signal transmitted via modal antenna 100. For example, the one or more channel quality indicators may include a signal-to-noise ratio (SNR), signal to interference-plus-noise ratio (SINR), receive signal strength indicator (RSSI), bit error rate (BER) and/or other quality metrics.

In some embodiments, the one or more control devices 550 can be in electrical communication with the radio frequency (RF) circuitry 540. In this manner, RF signals received at the modal antenna 100 (e.g., antenna element 110 of modal antenna 100) can be provided to the one or more control devices 550 via the RF circuitry 540. In addition, the one or more control devices 550 can provide data to be modulated onto a transmit RF signal provided to the antenna element 110 of the modal antenna 100 via the RF circuitry 540. For instance, RF circuitry 540 may include an RF feed line and/or matching circuitry. RF signals and/or a control signal may be communicated over a transmission line (e.g., coaxial cable).

As shown, the one or more control devices 550 can include one or more processors 552 and one or more memory devices 554. The processor(s) 552 can include any suitable processing device, such as a microprocessor, microcontroller, integrated circuit, logic device, or other suitable processing device. The memory device(s) 554 can include one or more computer-readable media, including, but not limited to, non-transitory computer-readable media, RAM, ROM, hard drives, flash drives, or other memory devices.

The memory device(s) 554 can store information accessible by the processor(s) 552, including computer-readable instructions that can be executed by the processor(s) 552. The computer-readable instructions can be any set of instructions that, when executed by the processor(s) 552, cause the processor(s) 552 to perform operations. The computer-readable instructions can be software written in any suitable programming language or may be implemented in hardware. In some embodiments, the computer-readable instructions can be executed by the processor(s) 552 to cause the processor(s) 552 to perform operations, such as controlling operation of the modal antenna 100.

In some embodiments, electronic device 500 may be a keyless entry device to be used, for instance, in keyless entry applications. In such application, it may be important to determine whether signals are being received by a legitimate entry device or if they are coming from a security compromised device (e.g., a device that is not located where it should be located). This can be particularly useful, for instance, in preventing the unauthorized capturing of information for keyless entries by devices that are not located proximate to equipment (e.g., automotive vehicle) or premises (e.g., a building). Signal metrics such as signal direction, angle of arrival, and/or time of flight of a received signal may be used to validate a device. Accordingly, the one or more control devices 550 of electronic device 500 may be configured to determine one or more signal metrics based at least in part on a selected mode of the modal antenna 100. For example, one or more control devices 550 may determine that a signal is being received by a legitimate entry device based at least in part on a selected mode of the modal antenna 100 at the time the signal is received.

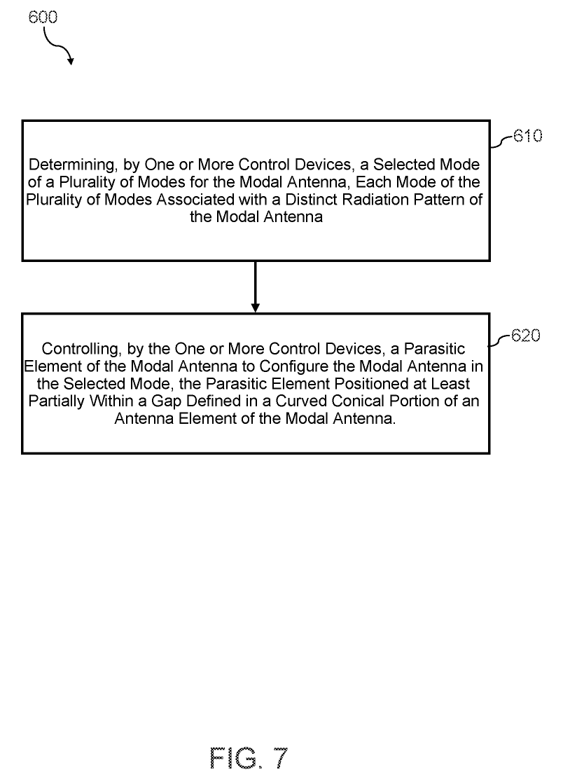

Referring now to FIG. 7, a flow diagram of a method 600 for controlling operation of a modal antenna is provided according to example embodiments of the present disclosure. In general, the method 600 will be discussed herein with reference to the electronic device 500 described above with reference to FIG. 6. In addition, although FIG. 7 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

At (610), the method 600 can include determining, by one or more control devices, a selected mode of a plurality of modes for the modal antenna, each mode of the plurality of modes associated with a distinct radiation pattern of the modal antenna. For instance, as shown in FIG. 6, one or more control devices 550 may determine a selected mode of a plurality of modes of the modal antenna 100.

At (620), the method 600 can include controlling, by the one or more control devices, a parasitic element of the modal antenna to configure the modal antenna in the selected mode, the parasitic element positioned at least partially within a gap defined in a curved conical portion of an antenna element of the modal antenna. For instance, as shown in FIG. 6, the one or more control devices 550 may control parasitic element 150 of modal antenna 100 in the selected mode. As shown in FIG. 1, the parasitic element 150 of modal antenna 100 may be positioned at least partially within a gap 116 defined in a curved conical portion 112 of an antenna element 110 of the modal antenna 100.

One aspect of the present disclosure is directed to a modal antenna. The modal antenna includes an antenna element comprising a curved conical portion and a top portion, the top portion comprising an undulating annular ring disposed on the curved conical portion. The modal antenna further includes a parasitic element positioned at least partially within a gap defined in the curved conical portion of the antenna element.

In some examples, the modal antenna further includes an active tuning element coupled to the parasitic element, the active tuning element configured to adjust a mode of the modal antenna among a plurality of modes, each mode of the plurality of modes associated with a distinct radiation pattern.

In some examples, the active tuning element is configured to adjust the mode of the modal antenna by varying a reactance associated with the parasitic element.

In some examples, the active tuning element is configured to couple the parasitic element to a ground plane.

In some examples, the undulating annular ring comprises a sinusoid structure.

In some examples, the modal antenna is configured to operate at frequencies in a range from about 3 GHz to about 12 GHz.

In some examples, the modal antenna is a laser direct structuring (LDS) defined antenna.

In some examples, the modal antenna further includes a carrier comprising a first portion configured to support at least a portion of the antenna element and a base portion configured to support the first portion. A first surface of the base portion is configured to operatively couple the modal antenna to a circuit board.

In some examples, the parasitic element extends from the gap defined in the curved conical portion of the antenna element to the first surface of the base portion of the carrier.

In some examples, one or more control devices are operably coupled to the active tuning element, the one or more control devices configured to determine a selected mode of the plurality of modes based at least in part on one or more channel quality indicators.

Another aspect of the present disclosure is directed to a method for controlling a modal antenna. The method includes determining, by one or more control devices, a selected mode of a plurality of modes for the modal antenna, each mode of the plurality of modes associated with a distinct radiation pattern of the modal antenna. The method further includes controlling, by the one or more control devices, a parasitic element of the modal antenna to configure the modal antenna in the selected mode, the parasitic element positioned at least partially within a gap defined in a curved conical portion of an antenna element of the modal antenna.

In some examples, the antenna element comprises the curved conical portion and a top portion, the top portion comprising an undulating annular ring disposed on the curved conical portion.

In some examples, the undulating annular ring comprises a sinusoid structure.

In some examples, the selected mode is based at least in part on one or more channel quality indicators.

In some examples, the modal antenna is configured to operate at frequencies in a range from about 3 GHz to about 12 GHz.

Another aspect of the present disclosure is directed to an electronic device. The electronic device includes a circuit board having a ground plane. The electronic device further includes a modal antenna positioned on a first surface of the circuit board. The modal antenna includes an antenna element comprising a curved conical portion and a top portion, the top portion comprising an undulating annular ring disposed on the curved conical portion. The modal antenna further includes a parasitic element positioned at least partially within a gap defined in the curved conical portion of the antenna element.

In some examples, the electronic device further includes an active tuning element coupled to the parasitic element, the active tuning element configured to adjust a mode of the modal antenna among a plurality of modes, each mode of the plurality of modes associated with a distinct radiation pattern.

In some examples, the electronic device further includes one or more control devices operably coupled to the active tuning element, the one or more control devices configured to determine a selected mode of the plurality of modes based at least in part on one or more channel quality indicators.

In some examples, the modal antenna is configured to operate at frequencies in a range from about 3 GHz to about 12 GHz.

In some examples, the electronic device is a keyless entry device.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A modal antenna, comprising:
an antenna element comprising a curved conical portion and a top portion, the top portion comprising an undulating annular ring on the curved conical portion; and
a parasitic element positioned at least partially within a gap defined in the curved conical portion of the antenna element.

2. The modal antenna of claim 1, further comprising:
an active tuning element coupled to the parasitic element, the active tuning element configured to adjust a mode of the modal antenna among a plurality of modes, each mode of the plurality of modes associated with a distinct radiation pattern.

3. The modal antenna of claim 2, wherein the active tuning element is configured to adjust the mode of the modal antenna by varying a reactance associated with the parasitic element.

4. The modal antenna of claim 2, wherein the active tuning element is configured to couple the parasitic element to a ground plane.

5. The modal antenna of claim 1, wherein the undulating annular ring comprises a sinusoid structure.

6. The modal antenna of claim 1, wherein the modal antenna is configured to operate at frequencies in a range from about 3 GHz to about 12 GHz.

7. The modal antenna of claim 1, wherein the modal antenna is a laser direct structuring (LDS) defined antenna.

8. The modal antenna of claim 1, further comprising:
a carrier comprising a first portion configured to support at least a portion of the antenna element and a base portion configured to support the first portion,
wherein a first surface of the base portion is configured to operatively couple the modal antenna to a circuit board.

9. The modal antenna of claim 8, wherein the parasitic element extends from the gap defined in the curved conical portion of the antenna element to the first surface of the base portion of the carrier.

10. The modal antenna of claim 2, wherein one or more control devices are operably coupled to the active tuning element, the one or more control devices configured to determine a selected mode of the plurality of modes based at least in part on one or more channel quality indicators.

11. A method for controlling a modal antenna, the method comprising:
determining, by one or more control devices, a selected mode of a plurality of modes for the modal antenna, each mode of the plurality of modes associated with a distinct radiation pattern of the modal antenna; and
controlling, by the one or more control devices, a parasitic element of the modal antenna to configure the modal antenna in the selected mode, the parasitic element positioned at least partially within a gap defined in a curved conical portion of an antenna element of the modal antenna.

12. The method of claim 11, wherein the antenna element comprises the curved conical portion and a top portion, the top portion comprising an undulating annular ring disposed on the curved conical portion.

13. The method of claim 12, wherein the undulating annular ring comprises a sinusoid structure.

14. The method of claim 11, wherein the selected mode is based at least in part on one or more channel quality indicators.

15. The method of claim 11, wherein the modal antenna is configured to operate at frequencies in a range from about 3 GHz to about 12 GHz.

16. An electronic device, comprising:
a circuit board having a ground plane;
a modal antenna positioned on a first surface of the circuit board, the modal antenna comprising:
an antenna element comprising a curved conical portion and a top portion, the top portion comprising an undulating annular ring disposed on the curved conical portion; and
a parasitic element positioned at least partially within a gap defined in the curved conical portion of the antenna element.

17. The electronic device of claim 16, further comprising:
an active tuning element coupled to the parasitic element, the active tuning element configured to adjust a mode of the modal antenna among a plurality of modes, each mode of the plurality of modes associated with a distinct radiation pattern.

18. The electronic device of claim 17, further comprising:
one or more control devices operably coupled to the active tuning element, the one or more control devices configured to determine a selected mode of the plurality of modes based at least in part on one or more channel quality indicators.

19. The electronic device of claim 16, wherein the modal antenna is configured to operate at frequencies in a range from about 3 GHz to about 12 GHz.

20. The electronic device of claim 16, wherein the electronic device is a keyless entry device.
